(19) United States
(12) Patent Application Publication
(10) Pub. No.: US 2020/0150803 A1
(43) Pub. Date: May 14, 2020

(54) TOUCH PANEL WITH MULTIPOINT ARRAY SENSING ANTENNA

(71) Applicant: Chih-Ming LIU, New Taipei City (TW)

(72) Inventor: Chih-Ming LIU, New Taipei City (TW)

(21) Appl. No.: 16/664,950

(22) Filed: Oct. 28, 2019

(30) Foreign Application Priority Data
Nov. 12, 2018 (TW) 107140028

(51) Int. Cl. G06F 3/046; G01S 7/02; H01Q 1/24; H01Q 1/44

(52) U.S. Cl. CPC G06F 3/046; H01Q 1/44; H01Q 1/243; G01S 7/024

(57) ABSTRACT

The present invention provides a touch panel with multipoint array sensing antenna, comprising: a panel, including a layout area; multiple sensing antenna sets, distributed in a rectangular array in aforesaid layout area, wherein each sensing antenna set comprises at least one receiving antenna unit and at least one transmitting antenna unit, which are assembled in a range of area, and the receiving antenna unit is capable of receiving an antenna signal from the transmitting antenna unit; and a touch device, made of a material weakening or amplifying the antenna signal; when the touch device moves to a range where anyone of multiple sensing antenna sets is capable of receiving or transmitting the antenna signal, the antenna signal received by the receiving antenna unit changes, and the touch device corresponded to a position of the panel is able to be judged by an antenna signal change in the position.

### FIELD OF THE INVENTION

The present invention relates to a touch panel with multipoint array sensing antenna. In particular, it relates to a touch panel having multiple sensing antenna distributed by array, thereby judging a position by signal change from part of antenna.

### BACKGROUND OF THE INVENTION

With the development of electronic technology, the input type of human-machine interface has also increased. In order to pursue the intuitiveness of operation and improve the operation convenience, the touch input method is widely used in various types of electronic products. In general, touch input types include electromagnetic touch, resistive touch, and capacitive touch.

The input signal by electromagnetic touch is obtained by the interaction between touch panel and the magnetic digital pen. Generally, the sensing antennas are arranged in a two-dimensional array in the touch panel. The operation principle of the electromagnetic touch is that the magnetic force between the sensing antenna and the digital pen changes with the distance change between the touch panel and the digital pen, and then the position of digital pen on the track pad can be obtained according to the magnetic change of the sensing antenna.

Capacitive touch is based on the configured capacitive sensing circuit, which makes use of the conductive characteristics of the human finger. The power signal can be affected when the panel is touched, and then estimate the position of the finger by estimating the signal difference, and then the stylus is directly replaced.

However, in the conventional technology, both types of applications are technically different, and there are some unchangeable technology defects. The electromagnetic touch technology must rely on a stylus that can emit signals, and the battery is configured into the stylus to generate a signal. In the capacitive touch technology, because of the conductive property, it is affected by other conductors such as water. In summary, if touch operation is performed in a working environment with moisture, even in an underwater working environment and the touch panel is without battery, the conventional electromagnetic or capacitive touch technology can't be reached.

In summary, the inventor of the present invention contemplates and designs an touch panel with multipoint array sensing antenna to improve the lack of the conventional technology, thereby enhancing the implementation and utilization of the industry.

The above information disclosed in this section is only for enhancement of understanding of the background of the described technology and therefore it may contain information that does not form the prior art that is already known to a person of ordinary skill in the art.

### SUMMARY OF THE INVENTION

In view of the above-mentioned deficiencies of the conventional technology, the present invention is to design a touch panel with multipoint array sensing antenna with patentability, novelty and industrial utilization, to overcome the difficulties of the conventional technology.

The present invention provides a c touch panel with multipoint array sensing antenna, comprising: a panel, including a layout area; multiple sensing antenna sets, distributed in a rectangular array in the layout area of the panel, wherein each the sensing antenna set comprises a least one receiving antenna unit and at least one transmitting antenna unit, which are assembled in a range of area, and the receiving antenna unit is capable of receiving an antenna signal from the transmitting antenna unit; and a touch device, made of a material weakening or amplifying the antenna signal, wherein when the touch device moves to a range where anyone of the multiple sensing antenna sets are capable of receiving or transmitting the antenna signal, the antenna signal received by the receiving antenna unit changes, and the touch device corresponded to a position of the panel is able to be judged by an antenna signal change in the position.

In the embodiment of the present invention, each the sensing antenna set comprises the one receiving antenna unit and the multiple transmitting antenna units, and the transmitting antenna unit is smaller than and distributed in the receiving antenna unit.

In the embodiment of the present invention, each the sensing antenna set comprises the one receiving antenna unit and the one transmitting antenna unit, and the transmitting antenna unit is smaller than and distributed in the receiving antenna unit.

In the embodiment of the present invention, the receiving antenna unit and the transmitting antenna unit are disposed on an identical plane.

In the embodiment of the present invention, the receiving antenna unit and the transmitting antenna unit are disposed on two planes with height difference.

In the embodiment of the present invention, the layout area is a rectangle.

The touch panel with multipoint array sensing antenna of the present invention is designed to judge the touch position by signal change from the multiple sensing antenna sets. The method can avoid the problem by using capacitive touch technology under water, and the stylus only needs to select water resistance materials and does not need the battery to transmit the signal, such as electromagnetic touch technology. This is a novel application in the field of touch panel.

In addition, the multiple sensing antenna sets on the panel are distributed in a multiple points in a rectangular array. Unlike the conventional touch technology, multiple touch panels cannot be combined to form a larger touch panel. The present invention can form an enlarged touch panel and maintain each part by combining a plurality of touch panel with multipoint array sensing antenna side by side. The large panel with independent touch point sensing function has high flexibility which is not available in the conventional touch panel. This is impossible for the conventional touch technology.

Many of the attendant features and advantages of the present invention will become better understood with reference to the following detailed description considered in connection with the accompanying drawings.

### BRIEF DESCRIPTION OF THE DRAWINGS

The detailed structure, operating principle and effects of the present invention will now be described in more details hereinafter with reference to the accompanying drawings that show various embodiments of the present invention as follows.

FIG. 1 is a configuration diagram of a touch panel with multipoint array sensing antenna in the present invention.

FIG. 2 is an operation diagram of a touch panel with multipoint array sensing antenna in the present invention.

FIG. 3 is a configuration diagram with part of elements of a touch panel with multipoint array sensing antenna in the present invention.

FIG. 4 is another configuration diagram with part of elements of a touch panel with multipoint array sensing antenna in the present invention.

FIG. 5 is an embodiment diagram of a touch panel with multipoint array sensing antenna in the present invention.

### DETAILED DESCRIPTION OF THE PREFERRED EMBODIMENTS

Reference will now be made in detail to the exemplary embodiments of the present invention, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this invention will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way.

For convenience, certain terms employed in the specification, examples and appended claims are collected here. Unless defined otherwise, all technical and scientific terms used herein have the same meaning as commonly understood by one of the ordinary skill in the art to which this invention belongs.

Various embodiments will now be described more fully with reference to the accompanying drawings, in which illustrative embodiments are shown. The inventive concept, however, may be embodied in various different forms, and should not be construed as being limited only to the illustrated embodiments. Rather, these embodiments are provided as examples, to convey the inventive concept to one skilled in the art. Accordingly, known processes, elements, and techniques are not described with respect to some of the embodiments.

The singular forms “a”, “and”, and “the” are used herein to include plural referents unless the context clearly dictates otherwise.

The following descriptions are provided to elucidate the process of preparing a composition used for manufacturing gloves and to aid it of skilled in the art in practicing this invention. These Examples are merely exemplary embodiments and in no way to be considered to limit the scope of the invention in any manner.

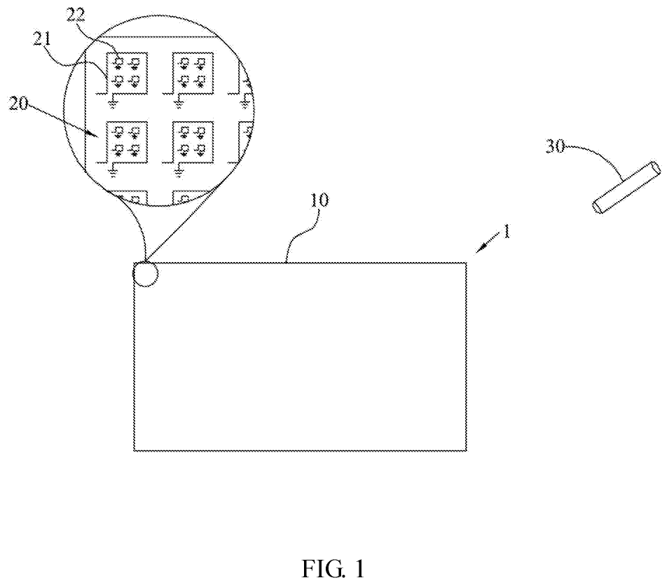

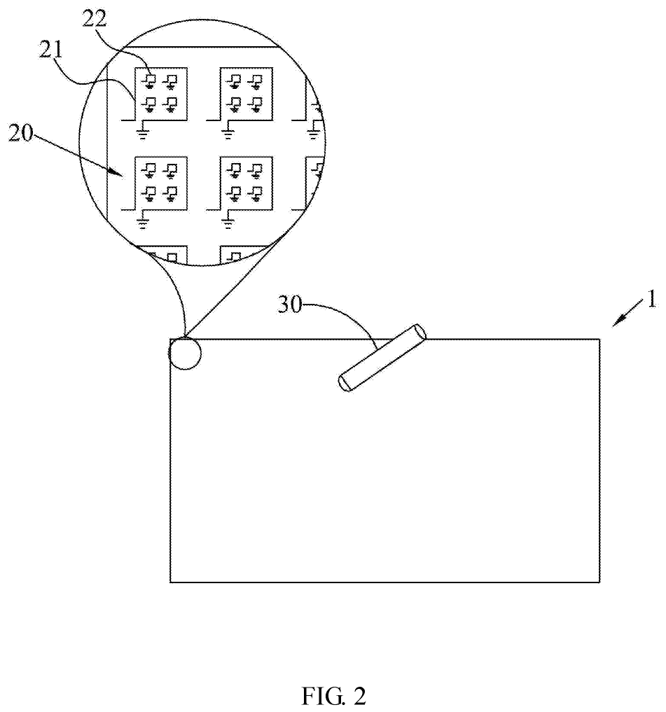

Please refer to FIG. 1 and FIG. 2, the present invention provides a touch panel with multipoint array sensing antenna 1, comprising a panel 10, multiple sensing antenna sets 20, and a touch device 30.

The panel 10 has a layout area, and the layout area is a rectangle.

The multiple sensing antenna sets 20 are distributed in a rectangular array in the layout area of the panel 10 to form the multiple sensing points in an array. Each the sensing antenna set 20 comprises at least one receiving antenna unit 21 and at least one transmitting antenna unit 22, which are assembled in a range of area. The receiving antenna unit 21 can continuously receive an antenna signal from the transmitting antenna unit 22.

The touch device 30 is made of a material that weakens or amplifies the antenna signal, such as a magnetic conductive material or a metal material. When the touch device 30 moves to the range where anyone of the multiple sensing antenna sets 20 can receive or transmit the antenna signal, the antenna signal received by the receiving antenna unit 21 changes. The touch device 30 corresponded to a position of the panel 10 can be judged by a antenna signal change in that position.

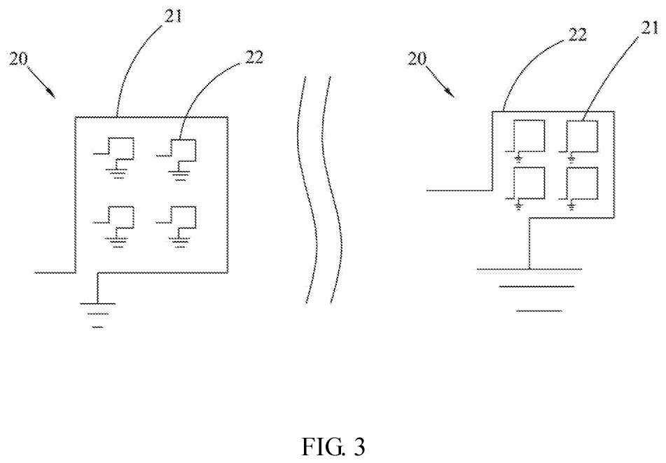

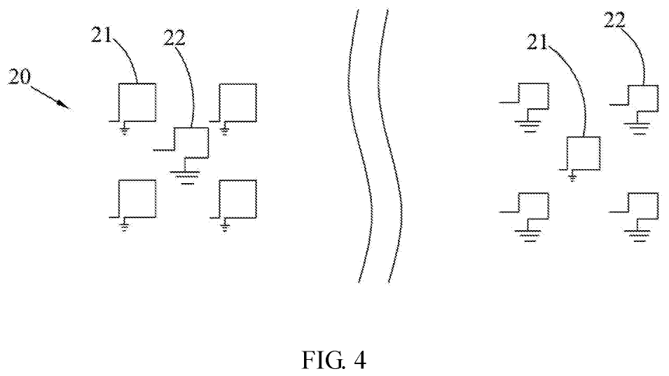

Please refer to FIG. 3, the position relationship between the receiving antenna unit 21 and the transmitting antenna unit 22 is shown. The receiving antenna unit 21 can be bigger than the transmitting antenna unit 22, and the receiving antenna unit 21 is coated on an outside of the transmitting antenna unit 22, or vice versa. Please refer to FIG. 4, the position relationship between the receiving antenna unit 21 and the transmitting antenna unit 22 is also shown. The receiving antenna unit 21 can be disposed on the center of the transmitting antenna unit 22, and the transmitting antenna unit 22 surrounds the receiving antenna unit 21, or vice versa. They are disposed on an identical plane, or respectively disposed on two planes with height difference. As long as they are capable of achieving the signal transmission within the range of area, that can be applied in the present invention.

The touch panel with multipoint array sensing antenna 1 of the present invention is designed to judge the touch position by signal change from the multiple sensing antenna sets 20. The method can avoid the problem by using capacitive touch technology under water, and the stylus only needs to select water resistance materials and does not need the battery to transmit the signal, such as electromagnetic touch technology. This is a novel application in the field of touch panel.

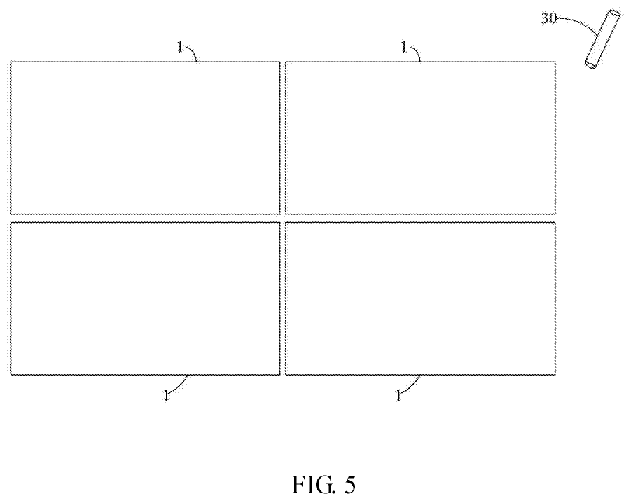

In addition, the multiple sensing antenna sets 20 on the panel 10 are distributed in a multiple points in a rectangular array. Unlike the conventional touch technology, multiple touch panels cannot be combined to form a larger touch panel. Please refer to FIG. 5, the present invention can form an enlarged touch panel and maintain each part by combining a plurality of touch panel with multipoint array sensing antenna 1 side by side. The large panel with independent touch point sensing function has high flexibility which is not available in the conventional touch panel. This is impossible for the conventional touch technology.

It will be understood that the above description of embodiments is given by way of example only and that various modifications may be made by those with ordinary skill in the art. The above specification, examples, and data provide a complete description of the present invention and use of exemplary embodiments of the invention. Although various embodiments of the invention have been described above with a certain degree of particularity, or with reference to one or more individual embodiments, those with ordinary skill in the art could make numerous alterations or modifications to the disclosed embodiments without departing from the spirit or scope of this invention.

What is claimed is:

1. A touch panel with multipoint array sensing antenna, comprising:
a panel, including a layout area;
multiple sensing antenna sets, distributed in a rectangular array in the layout area of the panel, wherein each the sensing antenna set comprises a receiving antenna unit and multiple transmitting antenna units, each the transmitting antenna unit is smaller than and distributed in the receiving antenna unit, and the receiving antenna unit is capable of receiving an antenna signal from the transmitting antenna unit; and
a touch device, made of a material weakening or amplifying the antenna signal, wherein when the touch device moves to a range where anyone of the multiple sensing antenna sets are capable of receiving or transmitting the antenna signal, the antenna signal received by the receiving antenna unit changes, and the touch device corresponded to a position of the panel is able to be judged by an antenna signal change in the position.

2. The touch panel with multipoint array sensing antenna as defined in claim 1, wherein each the sensing antenna set comprises the one receiving antenna unit and the one transmitting antenna unit, and the transmitting antenna unit is smaller than and distributed in the receiving antenna unit.

3. The touch panel with multipoint array sensing antenna as defined in claim 1, wherein the receiving antenna unit and the transmitting antenna unit are disposed on an identical plane.

4. The touch panel with multipoint array sensing antenna as defined in claim 1, wherein the receiving antenna unit and the transmitting antenna unit are disposed on two planes with height difference.

5. The touch panel with multipoint array sensing antenna as defined in claim 1, wherein the layout area is a rectangle.
